(19) United States
(12) Patent Application Publication
(10) Pub. No.: US 2005/0004877 A1
(43) Pub. Date: Jan. 6, 2005

(54) Method and system for parcel redirection

(75) Inventors: Kerry McLellan, Rothesay (CA); Christopher Magee, Saint John (CA); Paul Mansz, Rothesay (CA); Fred Bullock, Nauwigewauk (CA); Greg Parker, Quispamsis (CA); Jeff Sheehan, Saint John (CA); Lorie Vaughan, Quispamsis (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Kinek Technologies Inc., Saint John (CA)

(21) Appl. No.: 10/611,943

(22) Filed: Jul. 3, 2003

(51) Int. Cl. G06F 17/60

(52) U.S. Cl. 705/400

(57) ABSTRACT

A method of delivering a parcel to a recipient is disclosed. The method includes the steps of: a) attempting a delivery at a primary location; and b) if the delivery fails, delivering the parcel to a preferred redirection location, where the preferred redirection location is selected by the recipient.

### FIELD OF THE INVENTION

The present invention relates generally to parcel delivery, and in particular, to a method and apparatus for redirecting parcels.

### BACKGROUND OF THE INVENTION

Parcel delivery is a growing business in the United States and worldwide. The growth is due in significant part to recent increases in catalog and Internet shopping. In order to keep up with the growth, delivery organizations (including post offices) are searching for more efficient methods of transporting parcels to their final destinations.

A common problem with established delivery processes is a situation where a parcel cannot be delivered to a residential address because no one is there to receive it. Delivery organizations solve this problem in a number of ways. In some cases, the delivery organization may assume that, if a signature confirmation has not been explicitly required, it may be left at the doorstep. Some make repeat visits to the residence hoping to find someone at home. If after a pre-determined number of visits the parcel is still undelivered, it is taken to another location and the recipient is required to go to that location to retrieve the package. In most cases, this location and its hours of operation are not convenient for the recipient.

Another well known solution, typically provided by postal organizations, is to take the package to a location of their designation after a single delivery attempt. Therefore, there has been no explicit consideration of the preferences or convenience of the consumer.

Accordingly, there is a need for a system and method of parcel redirection which provides greater convenience for the recipient while improving the likelihood of a successful delivery.

### SUMMARY OF THE INVENTION

According to a first aspect of the invention, a method of delivering a parcel to a recipient is provided. The method comprises: a) attempting a delivery at a primary location; and b) if the delivery fails, delivering the parcel to a preferred redirection location, where the preferred redirection location is selected by the recipient. Preferably, the method further comprises notifying the recipient by email or SMS message that the parcel has been delivered to the preferred redirection location.

According to a second aspect of the invention, a system for delivering a parcel to a recipient is provided. The system comprises:
a) a mobile device operated by a delivery agent; and
b) a routing means for communication with said mobile device,
   wherein the mobile device is adapted to notify said routing means of a failed delivery to a primary location, said routing means being adapted to provide to the mobile device a preferred redirection location selected by the recipient.

The method and system according to the present invention provides improved convenience and control for the recipient by causing the parcel to be redirected to a location selected by the recipient, while at the same time increasing the likelihood that fewer repeat delivery attempts will be required to deliver the parcel. Preferably, the method and system of the present invention also allows the recipient to receive a notification upon delivery of the parcel to their preferred redirection location.

In order that a parcel may be redirected according to the recipient's wishes, the redirection preference is preferably accessible to the carrier, or delivery agent, at the time of delivery. One means of communicating the redirection preference is to have it printed or encoded directly on the parcel. Another means is to use a paper report that the delivery agent carries, listing all recipients on the delivery agent's route who have specified preferences with the delivery agent's organization. Another alternative means is to use a mobile device with either a real-time connection over a network to a routing application with a database that stores redirection information, or a store-and-forward device that is capable of communicating with the routing application on a periodic basis through an intermediary agent.

### BRIEF DESCRIPTION OF TH DRAWINGS

The preferred embodiment of the invention will now be described, by way of example only, with reference to the following figures:

FIG. 1 is a block diagram showing a system according to one embodiment of the present invention;

FIG. 2 is a block diagram detailing the system of FIG. 1;

FIG. 3 is a flow diagram illustrating a method according to one embodiment of the present invention;

FIG. 4 is a flow diagram showing in detail the confirm step of FIG. 3; and

FIG. 5 is a flow diagram showing in detail the redirection look-up step of FIG. 3.

### DETAILED DESCRIPTION OF THE INVENTION

As used in this application, “parcel” means any letter, package or the like suitable for delivery to a recipient. “Recipient” means the intended receiver of the parcel. “Delivery organization” means an entity, such as for example a company, responsible for delivery of the parcel. The delivery organization may be an organization in the parcel pick-up and delivery business, such as a courier company or a national post office. Alternatively, the delivery organization may be a part of another business, such as a merchant affiliated with an organization providing access to a network of alternate delivery locations. “Delivery agent” means a person or other entity contracted by the delivery organization to deliver the parcel.

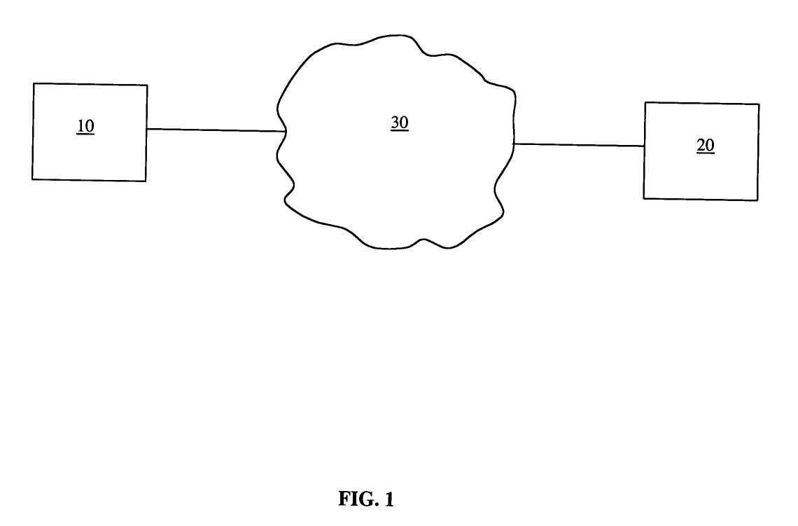

FIG. 1 shows one embodiment of a system for delivering a parcel to a recipient according to the present invention. The system includes a mobile device 10 which is capable of communication with a routing means 20 over a network 30.

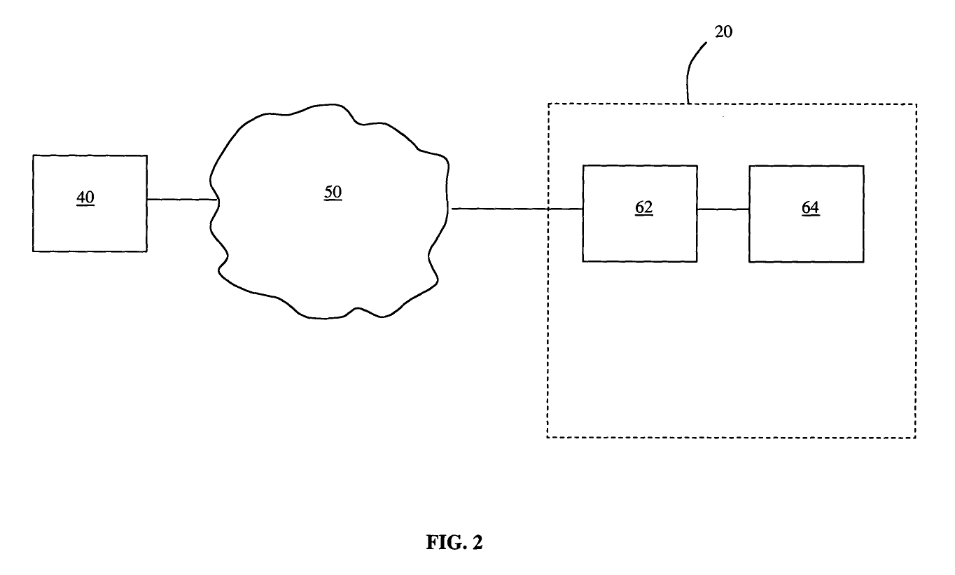

The mobile device 10 is operated by the delivery agent and may be any type of device capable of voice, data, or any other suitable type of two-way communication. For example, the mobile device 10 may be a telephone (cellular, satellite, landline, or the like), a pager, a personal digital assistant (PDA), a special purpose handheld delivery device (preferably integrating a barcode scanner), or a laptop computer. As shown in FIG. 2, the mobile device 10 is preferably an Internet-enabled PDA 40, running the Microsoft Windows CE® operating system.

The network 30 may be any suitable communication network such as a public switched telephone network (PSTN), a cellular or other wireless network, or any other voice or data network. As shown in FIG. 2, the network 30 preferably supports Internet protocols 50 although other data protocols, such as those based on Short Message Service (SMS), may be considered.

Referring to FIG. 2, the routing means 20 may be any means capable of providing a preferred redirection location selected by the recipient to the delivery agent. For example, the routing means 20 may be an office or call center which receives redirection location preferences and provides redirection locations by telephone or in person. Alternatively, the routing means 20 may be a self-service computer-based system, or a combination of both. The routing means 20 may be operated by the delivery organization. Alternatively, the operation of the routing means 20 may be outsourced by the delivery organization to a third party, such as for example, an application service provider.

Continuing to refer to FIG. 2, the routing means 20 is preferably a computer based system which includes a routing application 62, and a database 64. The PDA 40 communicates with the routing application 62 via the Internet 50 using TCP/IP (Transmission Control Protocol/Internet Protocol) or any other suitable protocol. The routing application 62 contains the intelligence for receiving, storing, and providing preferred redirection locations.

The routing application 62 is in communication with the database 64, on which the recipient information and preferred redirection locations are stored. The database 64 may be any suitable database, such as a Sybase® database. Preferably, the routing application is written in the Java programming language and includes a JDBC (Java Database Connectivity) interface to permit communication with the database 64 in SQL (Structured Query Language).

In order to provide one or more of the preferred redirection locations to the routing means 20, the recipient may initially register with the delivery organization. The registration may take place electronically (such as via the Internet), or in any other supported manner, such as in person, by mail, or by telephone (such as via a call center). As part of the registration process, the recipient may provide to the delivery organization certain recipient information, such as credentials that may be used later to identify the recipient (e.g. a user name and password), the recipient's name, recipient's primary location, and one or more preferred redirection locations. Typically, the primary location is the recipient's home or business address, but it may be any other location chosen by the recipient.

The preferred redirection locations may include without limitation residential addresses of neighbors, business locations provisioned to receive deliveries on behalf of others (e.g. postal outlets, convenience stores, service stations), and automated delivery platforms (e.g. electronic delivery lockers). If multiple preferred redirection locations are specified, the recipient may be requested to rank them in order of preference. The types of locations the recipient is allowed to choose may be dependent upon rules established for each specific implementation. Although many possible rules would be apparent to those skilled in the art, one rule may use the address and geographic information of the primary location to limit the distance from the primary location the delivery agent would have to travel to reach the preferred redirection location. The routing application 62 may be configured not to allow the recipient to specify a preferred redirection location situated further from the primary location than a predetermined limit. If no preferred redirection locations are registered for the recipient, the routing application 62 may generate a default redirection location.

All of the information supplied by the recipient is stored in the database 64. When the registration process is complete, a unique identifier, may be assigned to the recipient. The unique identifier may be generated by the routing application 62, or it may be generated in some other manner by the delivery organization. If the preferred delivery location is a locker as mentioned above, the unique identifier may be the combination required to perform a delivery to the locker. In any event, information necessary to reconstruct the unique identifier is stored in the database 64 associated with the other recipient information described above.

The recipient may later be given the option of modifying the recipient information, such as the primary location or the preferred redirection location. For example, the recipient may log in to the routing application 62 via the Internet using previously established credentials and modify the recipient's primary or preferred redirection locations.

Prior to implementing the method according to the present invention, a shipment with a parcel will be originated for delivery to the recipient. Many ways of originating such shipments will be known to those skilled in the art. In one embodiment, the recipient will purchase a product on a web site operated by a merchant and the merchant will place the product into a parcel to be delivered to the recipient. In this embodiment, the recipient provides to the merchant the recipient's name and primary location (e.g. via an on-line form) when purchasing the product. The recipient may also enter the recipient's unique identifier when completing the on-line form. If the merchant has a relationship with the delivery organization, the on-line form provided by the merchant may include a field for the unique identifier. If the merchant has no relationship with the delivery organization, the recipient, or a form-filling application used by the recipient, may enter the unique identifier in another field, along with the required information for that field.

This unique identifier may be a recipient identifier, or a transaction identifier. The distinction is that the former will identify the recipient along with any static preferences or information that person has provided, including address, contact information, e-mail address, and redelivery preference(s). The latter would identify the person as above, but also indicate selections and preferences pertaining to that specific transaction with the merchant.

The merchant will then place the product into the parcel and request that the delivery agent from the delivery organization pick up the parcel for delivery to the recipient. The merchant will preferably generate a label for the parcel with the recipient's name and primary location. As described above, the label preferably includes the unique identifier of the recipient.

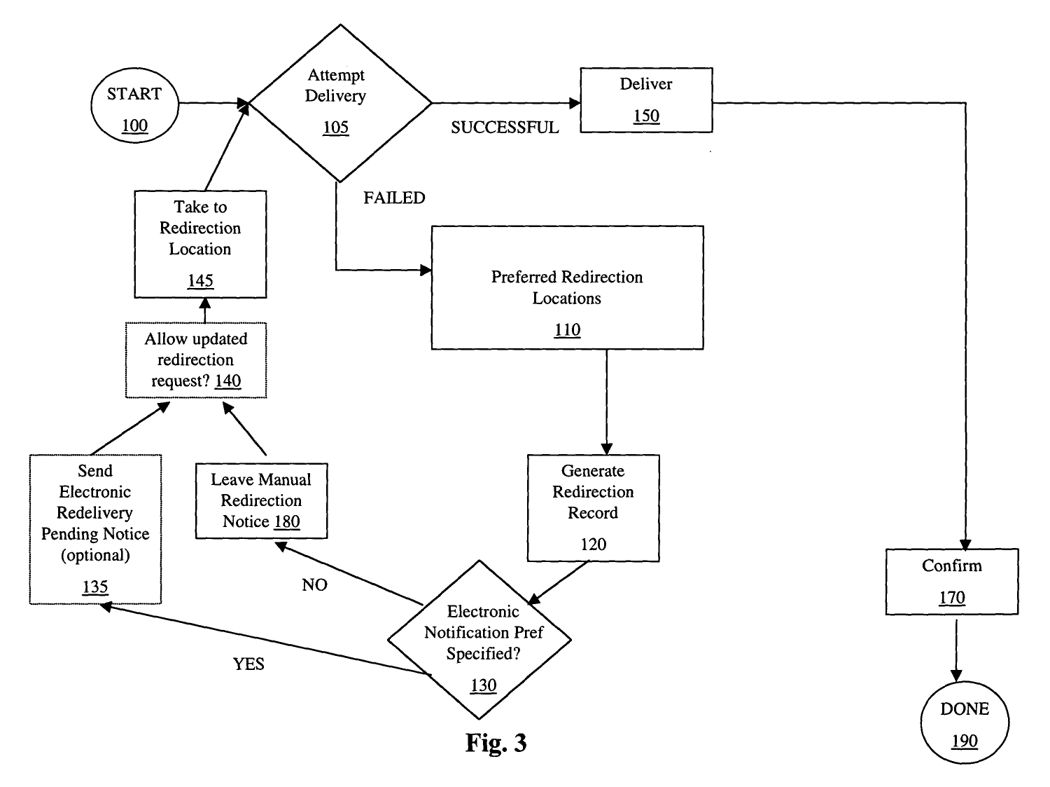

The method according to the present invention will now be described with reference to FIGS. 3, 4 and 5.

Referring to FIG. 3, the process flow begins at step 100. At step 105, the delivery agent attempts delivery of the parcel to the recipient at the primary location. If no one is there to receive the parcel, then the attempted physical delivery has failed. If the delivery did not fail, then the attempted delivery is successful.

If the attempted delivery is successful, the delivery agent proceeds to step 150. In this step, the delivery agent has delivered the package to the recipient's primary location or their preferred redirection location, as appropriate.

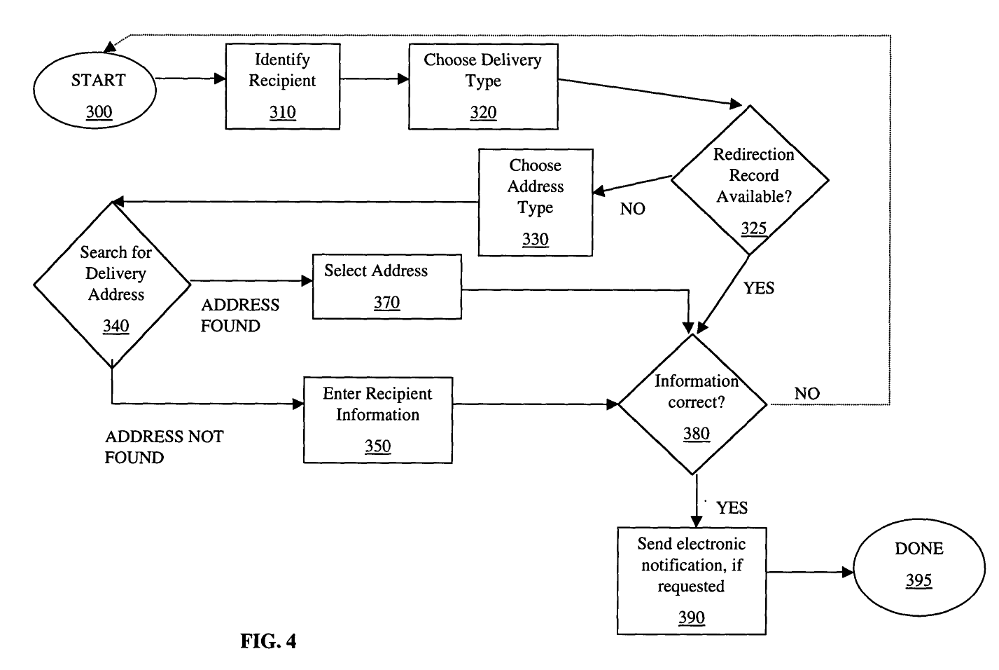

At step 170, the delivery agent confirms delivery. This step is illustrated in FIG. 4 and described in more detail below.

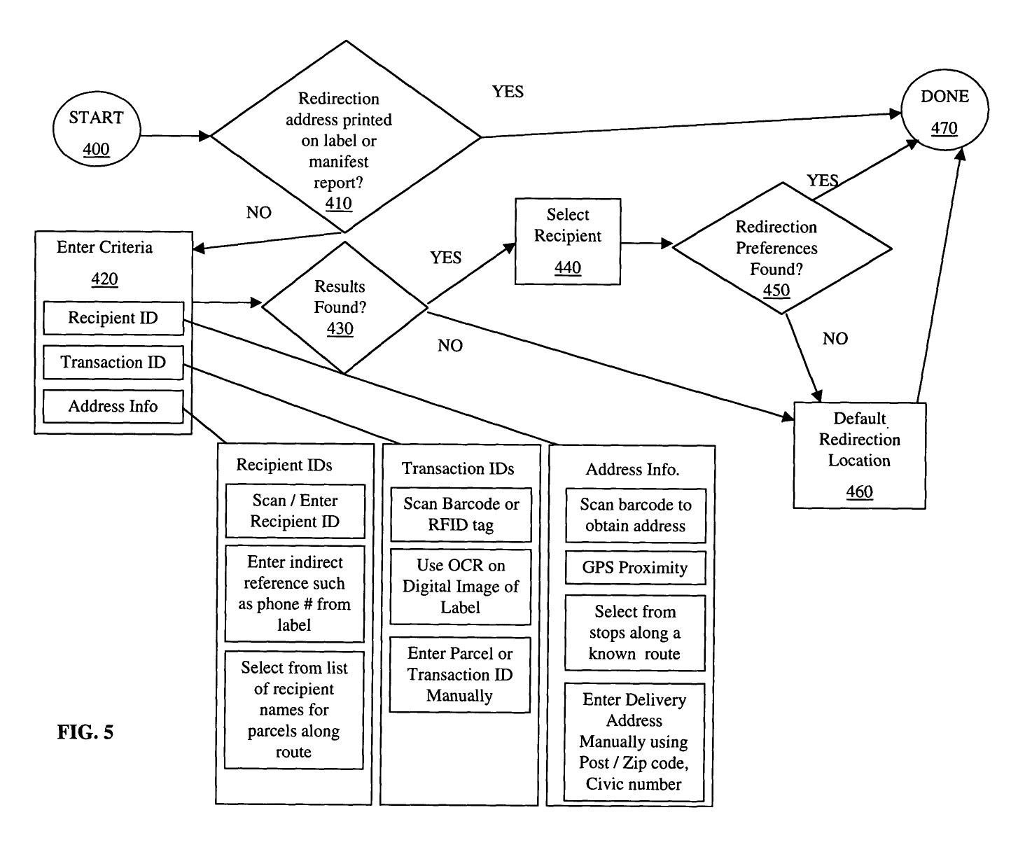

If the attempted delivery fails, the delivery agent moves to step 110 to identify the preferred redirection location to which the parcel should be redirected. This step is illustrated in FIG. 5 and described in more detail below. Once the preferred redirection location is determined, the process continues to step 120.

At step 120, the PDA 40 creates a record of the redirection for that recipient. Alternatively, the delivery agent manually records the redirection on a paper-based delivery manifestation.

At decision step 130, it is determined from the recipient information in the routing application whether electronic notification of the redirection is possible for the recipient. This would be the case, for example, if the recipient had specified an e-mail or SMS address to be used for notification. If so, the PDA 40 communicates at step 135 to the routing application 62 (or the redirection events noted manually on the delivery agent's redirection reports are posted to the routing application 62 at the end of the delivery agent's shift) which (optionally) may trigger an electronic redirection pending notice. If electronic notification is not possible, a manual notice will be left at the primary location, according to the delivery organization's normal business procedures, at step 180. The process flow continues to step 140.

A response from the recipient to either a manual notice or a redirection pending notice may return, from the routing application 62 to the PDA 40, an updated redirection request at step 140. This would override the existing redirection information on hand for the parcel and could occur on the same day as the initial delivery attempt, or later. If PDA 40 is equipped for two way real-time wireless communication, the recipient would have the opportunity to request that a different preferred redirection location be used. Alternatively, the parcel may be returned to a sorting facility overnight, with redirection being intended for the next day. The recipient may then have the opportunity to respond before morning and indicate a different preferred redirection location.

At step 145, the parcel is taken to the preferred redirection location, and the process flow continues to step 105 where the delivery is attempted at the preferred redirection location. This location may be a public or private address. It will be understood by those skilled in the art that redirection to the preferred redirection location may occur immediately (in the case of redirection to a neighbour), or may be deferred according to the location, preferences, and process of the delivery agent.

Referring now to FIG. 4, the confirm process (shown as step 170 in FIG. 3) will now be described in greater detail. The process flow starts at step 300. At step 310, the recipient is identified. If the delivery is to a preferred redirection location, this step requires referencing the recipient's redirection record to obtain the preferred redirection location. If the delivery is to a primary location, the recipient is preferably identified as shown in FIG. 5 below. At step 320, the delivery agent chooses the delivery type. The delivery type would typically include whether the parcel is being delivered to a primary location, a preferred redirection location, or a default redirection location. This information may be used by the routing application 62 to determine if a notification of redirection should be communicated to the recipient.

At decision step 325, it is determined whether a previously stored redirection record is available for this parcel. This would be the result of step 120 in FIG. 3. The process flow proceeds to step 380 if a record is available, and step 330 if not.

At step 330, the delivery agent chooses the address type, such as a private address or collection depot.

At step 340, the delivery agent searches the list of locations in the recipient's information (preferably stored in the PDA 40) for the address to which the delivery is being made. The list of locations preferably includes all locations that are relevant to the answers given in steps 320 and 330. These may include residential and/or public addresses from the recipient's information, other public locations, and the recipient's redirection preference(s).

If the location the parcel was delivered to appears in the list of locations for the recipient, the process flow moves to step 370. At step 370, the delivery agent selects the delivery location from the list. The process flow then moves to step 380, which is described below.

If the address the parcel was delivered to is not found at step 340, the process flow moves to step 350. At step 350, the delivery agent manually enters the address the parcel was delivered to and may additionally enter the recipient's name into the PDA 40. The process flow then moves to step 380.

At step 380, the PDA 40 displays all of the information chosen by the delivery agent and allows him or her to verify that the information is correct. If the information is not correct, the delivery agent may modify the information, at which point, the process flow moves to step 300. When the information is confirmed as correct by the delivery agent, the PDA 40 communicates the information to the routing application 62, which in turn stores the information on the database 64. At this point the process flow continues to step 390.

If notification for this delivery was requested by the recipient or required by the delivery organization's business process, the PDA 40 will trigger the routing application 62 to send an electronic notification at step 390. The process flow for FIG. 4 ends at step 395.

Preferably, a notification is generated only when the recipient has indicated that he/she would like to receive a notification. In the embodiment where the PDA 40 is not in real time communication with the routing application 62, the notification may be sent after the PDA 40 is synchronized with the routing means 20. In the embodiment where the delivery agent manually records the redirection and final delivery information on hard copy reports, the notification may be generated by the routing means 20 using the delivery agent's report after deliveries are finished or by batching sheets of printed deliveries.

The notification preferably includes information pertaining to the delivery or redirection event (e.g. date and time and location), and if the location is a locker, may include the combination to the locker.

Any suitable means of communicating this notification to the recipient may be used, including telephone, e-mail, SMS, voice-mail or other mechanisms by which the recipient could be contacted. Preferably the communication means would be specified by the recipient during registration for the service.

Referring now to FIG. 5, the redirection look-up process (shown as step 110 in FIG. 3) will be described in greater detail. The delivery agent preferably uses the PDA 40 to communicate in real time with the routing application 62, via a web services application over a wireless connection, to request the recipient's preferred redirection location.

A wide variety of methods of accessing the preferred redirection location will be known to those skilled in the art. In one embodiment, the delivery agent may send the unique identifier of the recipient to the routing application 62. The routing application then locates the recipient's information on the database 64 and retrieves the recipient information including without limitation the preferred redirection location. The routing application 62 then sends this information to the PDA 40.

In the embodiment shown in FIG. 5, the delivery agent may not be able to locate the preferred redirection location in a single step, and may require several steps to access the preferred redirection location. Such a situation may occur if, for example, the redirection information does not appear on the parcel and is not otherwise provided to the delivery agent.

Accordingly, the delivery agent may be required to enter search criteria at step 420. The purpose of the search is to locate the recipient, and/or the transaction, through a recipient identifier, a transaction identifier, or through address criteria. If a recipient identifier is provided, it may be printed directly on the parcel, or may be encoded in such a fashion that it can be scanned. The recipient identifier may also be located indirectly through a phone number or other identifying information on the parcel. A transaction identifier likewise could be printed on the parcel, or could be encoded through a bar code, an RFID (Radio Frequency Identification) tag, or determined through OCR (Optical Character Recognition) of a digital image of the parcel label. The address will typically be printed directly on the package, but may also be entered into the mobile device by scanning a bar code, selecting an address from delivery organization information, or could be obtained using GPS (Global Positioning System) data. The delivery agent enters the search criteria into the PDA 40, which in turn communicates the criteria to the routing application 62. The routing application retrieves all matching records from the database 64 and sends these records to the PDA 40.

If no records are found, the process flow proceeds to step 460 described below.

If one or more records are located as a result of the search, the delivery agent reviews the list of retrieved records at step 440 and selects the recipient's record from the list by any suitable means, such as, for example, matching the name and address to the label on the parcel.

It will be understood by those skilled in the art that the PDA 40 need not be capable of real time communication with the routing application 62. For example, all data and transactions may be stored on the PDA 40, and the PDA 40 may be periodically synchronized with the database 64. Although the synchronization may be carried out any number of times during a day, it would preferably be done before the delivery agent begins his or her deliveries and after the delivery agent finishes his or her deliveries. The purpose of synchronizing the PDA 40 before the delivery agent begins deliveries is for PDA 40 to receive updated information from the database 64 about recipients on the delivery agent's route. The purpose for synchronizing PDA 40 after the deliveries are completed is to transfer information regarding confirmed deliveries and redirected parcels to update the routing application 62 and database 64.

In an alternative embodiment where a mobile device is not used, the delivery agent is provided with a printed list to support that agent's deliveries, which includes each recipient's preferred redirection location(s).

In an alternative embodiment where a mobile device is not used, the delivery agent is provided with a printed list to support that agent's deliveries, which includes each recipient's preferred redirection location. In the event of a failed delivery attempt, the delivery agent would refer to the printed list to determine if the recipient's primary delivery location had a preferred redirection location associated with it. If not, a secondary redirection location, such as a default redirection location could be used.

If applicable, and multiple recipients at the primary delivery location had registered a redirection preference, the printed list would need to include the names, unique identifiers and preferred redirection locations for each registered recipient. In this case, the delivery agent would also need to compare the name on the package label with the recipients listed at the address to determine which redirection preference to use.

If applicable, the printed list may also include a unique identifier, such as a recipient or transaction code next to each address, to be used in a later step to generate an electronic redirection notification.

Preferably, the above-mentioned redirection and notification information would be integrated into a delivery manifest that may already be used to indicate the specific package number, recipient, delivery address and other related information for each package to be delivered on the delivery agent's route that day.

In another alternative embodiment, the preferred redirection location(s) may be printed on the parcel. This embodiment may be suitable where the merchant provides this information to the delivery organization.

Referring again to FIG. 5, the process flow moves to step 450. At this step, the delivery agent checks the recipient information to determine if they have specified one or more redirection locations. If a preferred redirection location is specified, it is displayed by the PDA 40 to the delivery agent. In the case of multiple redirection locations being specified by the recipient, the locations are displayed to the delivery agent. The delivery agent chooses the preferred redirection location preferably based on the priority specified by the recipient. Alternatively, the delivery agent may choose the preferred redirection location based on geographic proximity or based on the delivery agent's preference or based on some other relevant criteria. The location selected for redirection is recorded (“the redirection record”) in some fashion (e.g. by using the PDA 40, or by making a manual note on the printed report indicating the failure of the initial delivery attempt.) If either the printed list or package label contains a unique identifier, such as a recipient or transaction code to be used for an electronic redirection notification, this should be noted as well. Otherwise, the delivery agent may also need to complete a manual redelivery notice to leave at the recipient's primary address indicating that the delivery attempt occurred and appropriate redirection details.

If no preferred redirection location is specified the process flow moves to step 460. At this step, the delivery agent assigns a default redirection location (such as a post office or a locker) to the parcel, as discussed above, and the process flow ends at step 470.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of delivering a parcel to a recipient, comprising:
a) attempting a delivery at a primary location; and
b) if the delivery fails, delivering the parcel to a preferred redirection location;
wherein the preferred redirection location is selected by the recipient.

2. The method of claim 1, further comprising notifying the recipient that the parcel has been delivered to the preferred redirection location.

3. The method of claim 2, wherein the notification step comprises sending an email to the recipient.

4. The method of claim 2, wherein the notification step comprises sending a SMS message to the recipient.

5. The method of claim 2, wherein the notification step comprises batching manual records of deliveries.

6. The method of claim 2, further comprising the recipient communicating with a delivery service to change the redirection location.

7. The method of claim 2, wherein prior to step (a), the method further comprises registering with a delivery service.

8. The method of claim 7, wherein the registration step comprises providing the preferred redirection location to the delivery service.

9. The method of claim 8, wherein the registration step comprises providing the primary location to the delivery service.

10. The method of claim 8, wherein the registration step comprises generating an identifier unique to the recipient.

11. The method of claim 8, wherein the registration step comprises generating an identifier unique to the transaction.

12. The method of claim 9, wherein the primary location is a residential address of the recipient.

13. The method of claim 1, further comprising:
if the delivery to the preferred redirection location fails, delivering the parcel to a secondary redirection location.

14. The method of claim 13, wherein the secondary redirection location is a default redirection location selected by a delivery organization.

15. A system for delivering a parcel to a recipient, the system comprising:
a) a mobile device operated by a delivery agent;
b) a routing means for communication with said mobile device,
wherein the mobile device is adapted to notify said routing means of a failed delivery to a primary location, said routing means being adapted to provide to the mobile device a preferred redirection location selected by the recipient.

16. The system of claim 15, wherein the routing means is adapted to notify the recipient that the parcel is delivered to the redirection location.

17. The system of claim 16, wherein the routing means comprises a routing application adapted to receive the failed delivery notification and provide the preferred redirection location to the mobile device.

18. The system of claim 17, wherein the routing means further comprises a database adapted for communication with the routing application, the database being adapted to store the preferred redirection location.

19. The system of claim 15, wherein the mobile device comprises an Internet-enabled PDA.

20. The system of claim 15, wherein the mobile device and the routing means are adapted to communicate via the Internet.

21. The system of claim 18, wherein the routing application is adapted to send a delivery notification to the mobile device.
